(19) United States
(12) Patent Application Publication
(10) Pub. No.: US 2005/0097186 A1
(43) Pub. Date: May 5, 2005

(54) Method, system, and computer program product for managing interaction between remote devices and server resources

(75) Inventor: Richard Redpath, Cary, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/681,411

(22) Filed: Oct. 8, 2003

(51) Int. Cl. G06F 15/16

(52) U.S. Cl. 709/217; 709/218; 709/219

(57) ABSTRACT

A method and system by which a central server resource can be accessed by mobile employees for managing data, in both a connected or disconnected environment. A combined local mirror website and connection proxy is provided on a mobile user device, to provide access to essentially all web content available from the central server, or to a predefined subset thereof, but in an environment when the device is disconnected from the central server.

### BACKGROUND OF THE INVENTION

1. Field of the Invention

The present invention relates to a method and system for interaction between remotely-located devices and server resources and, more particularly, the present invention relates to a method and system by which an enterprise server resource can be accessed by mobile employees for managing data, in both a connected or disconnected environment.

2. Description of the Related Art

The Internet and wireless communication are permanently entrenched in today's business environment. It is increasingly becoming the rule, rather than the exception, for employees to operate and conduct their business away from the traditional desk, be it in a remote location within an employee site, from their home, from their vehicle, or from a vacation site. A “mobile employee” is an employee who conducts business using networks, such as the Internet, and wired and/or wireless technology (remotely-connected devices) to remain in touch with the enterprise and/or an enterprise server belonging to the organization to which they are employed.

Server systems provide data and interactive capability for mobile employee operations for the enterprise. Mobile employees can access enterprise server resources over the Web, and most currently available commercial connection systems provide cached web pages in a browser on the mobile or other remotely-connected device, so that previously received information can be accessed while disconnected, without the need to reconnect. Additionally, a separate proxy can be configured on the mobile device to capture outgoing data input to the device by the user when the mobile device is disconnected from the server.

The web page cache process is static and limited to the browsing paths previously executed by the mobile employee, i.e., the user cannot follow links on the cached pages that have not been previously accessed and cached, and the information that is viewable may be “stale”, since it is not updated until the user reconnects and accesses the page anew.

The use of a proxy requires the rewriting of the URL to which the outgoing data is being sent so that it goes to the proxy instead of attempting to find the URL on the disconnected server. This is cumbersome, time-consuming, and wasteful of computing resources.

Clearly, enterprise server resources need to be accessed by mobile employees within a realistic model in a transparent manner for a connected and disconnected environment. Therefore, a need exists for a method and system of providing seamless access to an enterprise server resource by a mobile employee to perform enterprise work.

### SUMMARY OF THE INVENTION

The present invention provides a method and system by which a central (e.g., enterprise) server resource can be accessed by mobile employees for managing data, in both a connected or disconnected environment. More specifically, in accordance with the present invention, a combination mirror/proxy is provided on a remote (e.g., mobile) user device, to provide access to essentially all web content available from the central server, or a predetermined subset thereof, in an environment in which the device is disconnected from the central server, while also providing a proxy for delivery (when connected) or storage (when disconnected) of requests directed to the central server resource.

### BRIEF DESCRIPTION OF THE DRAWINGS

FIG. 1 illustrates a representative workstation hardware environment in which the present invention may be practiced;

FIG. 2 illustrates an exemplary data processing network in which the present invention may be practiced;

FIG. 3 illustrates a prior art mobile-to-enterprise system;

FIG. 4 illustrates an example of a PDA configured in accordance with the present invention; and

FIG. 5 is a flowchart illustrating an example of steps performed in accordance with the present invention.

### DETAILED DESCRIPTION OF THE PREFERRED EMBODIMENTS

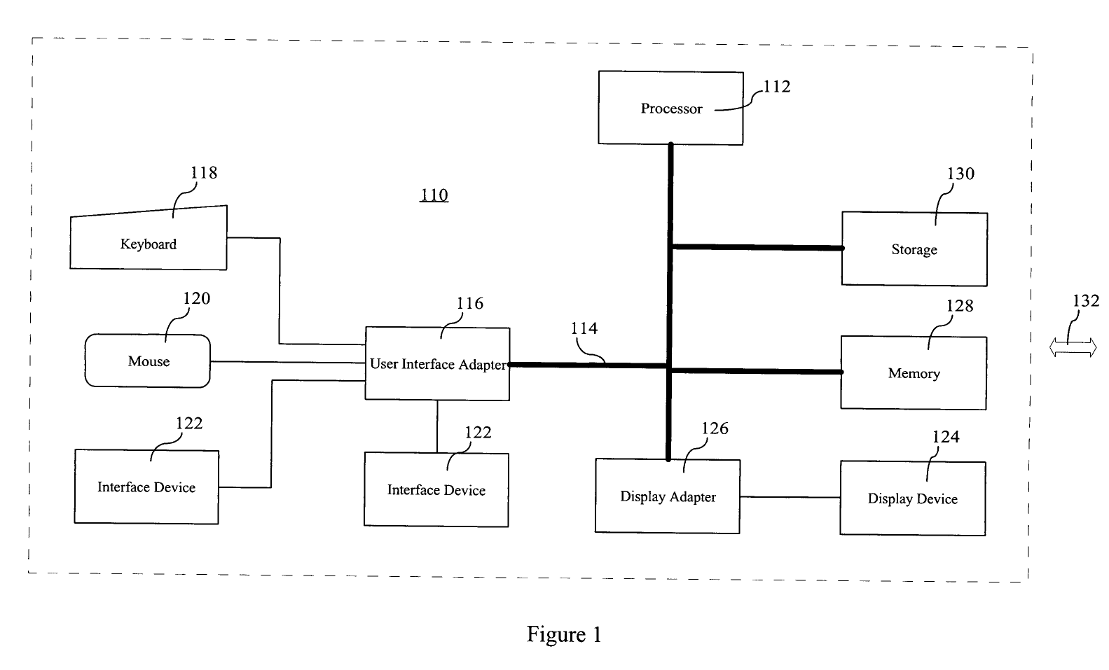

FIG. 1 illustrates a representative workstation hardware environment in which the present invention may be practiced. The environment of FIG. 1 comprises a representative single user computer workstation 110, such as a personal computer, including related peripheral devices. The workstation 110 includes a microprocessor 112 and a bus 114 employed to connect and enable communication between the microprocessor 112 and the components of the workstation 110 in accordance with known techniques. The workstation 110 typically includes a user interface adapter 116, which connects the microprocessor 112 via the bus 114 to one or more interface devices, such as keyboard 118, mouse 120, and/or other interface devices 122, which can be any user interface device, such as a touch sensitive screen, digitized entry pad, etc. The bus 114 also connects a display device 124, such as an LCD screen or monitor, to the microprocessor 112 via a display adapter 126. The bus 114 also connects the microprocessor 112 to memory 128 and long term storage 130 which can include a hard drive, tape drive, etc.

The workstation 110 communicates via a communications channel 132 with other computers or networks of computers. The workstation 110 may be associated with such other computers in a local area network (LAN) or a wide area network, or the workstation 110 can be client in a client/server arrangement with another computer, etc. All of these configurations, as well as the appropriate communications hardware and software, are known in the art.

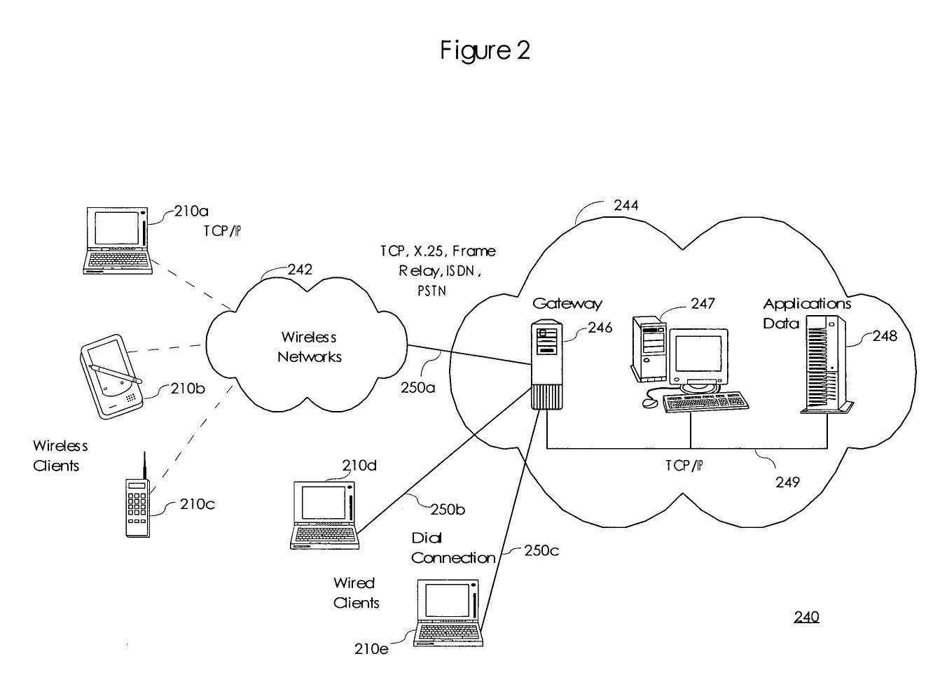

FIG. 2 illustrates an exemplary data processing network 240 in which the present invention may be practiced. The data processing network 240 may include a plurality of individual networks, such as wireless network 242 and network 244, each of which may include a plurality of individual workstations/devices, e.g. 210a, 210b, 210c. Additionally, as those skilled in the art will appreciate, one or more LANs may be included (not shown), where a LAN may comprise a plurality of intelligent workstations coupled to a host processor.

The networks 242 and 244 may also include mainframe computers or servers, such as a gateway computer 246 or application server 247 (which may access a data repository 248). A gateway computer 246 serves as a point of entry into each network 244. The gateway computer 246 may be preferably coupled to another network 242 by means of a communications link 250a. The gateway computer 246 may also be directly coupled to one or more workstations, e.g 210d, 210e using a communications link 250b, 250c. The gateway computer 246 may be implemented using any appropriate processor, such as IBM's Network Processor. For example, the gateway computer 246 may be implemented using an IBM pSeries (RS/6000) or xSeries (Netfinity) computer system, an Enterprise Systems Architecture/370 available from IBM, an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390”, “Application System/400”, and “AS/400” are registered trademarks of IBM.) These are merely representative types of computers with which the present invention may be used.

The gateway computer 246 may also be coupled 249 to a storage device (such as data repository 248). Further, the gateway 246 may be directly or indirectly coupled to one or more workstations/devices 210d, 210e, and servers such as application server 247.

Those skilled in the art will appreciate that the gateway computer 246 may be located a great geographic distance from the network 242, and similarly, the workstations/devices may be located a substantial distance from the networks 242 and 244. For example, the network 242 may be located in California, while the gateway 246 may be located in Texas, and one or more of the workstations/devices 210 may be located in New York. The workstations/devices 210 may connect to the wireless network 242 using a networking protocol such as the Transmission Control Protocol/Internet Protocol (“TCP/IP”) over a number of alternative connection media, such as cellular phone, radio frequency networks, satellite networks, etc. The wireless network 242 preferably connects to the gateway 246 using a network connection 250a such as TCP or UDP (User Datagram Protocol) over IP, X.25, Frame Relay, ISDN (Integrated Services Digital Network), PSTN (Public Switched Telephone Network), etc. The workstations/devices 210 may alternatively connect directly to the gateway 246 using dial connections 250b or 250c. Further, the wireless network 242 and network 244 may connect to one or more other networks (not shown), in an analogous manner to that depicted in FIG. 2.

The present invention may be used on a client computer or server in a networking environment, or on a standalone workstation (for example, to prepare a file or to process a file which has been received over a network connection, via a removable storage medium, etc.). (Note that references herein to client and server devices are for purposes of illustration and not of limitation: the present invention may also be used advantageously with other networking models.) When used in a networking environment, the client and server devices may be connected using a “wireline” connection or a “wireless” connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The workstation or client computer may be any type of computer processor, including laptop, handheld or mobile computers; vehicle-mounted devices; desktop computers; mainframe computers; etc., having processing (and, optionally, communication) capabilities. The server, similarly, can be one of any number of different types of computer which have processing and communication capabilities. These techniques are well known in the art, and the hardware devices and software which enable their use are readily available.

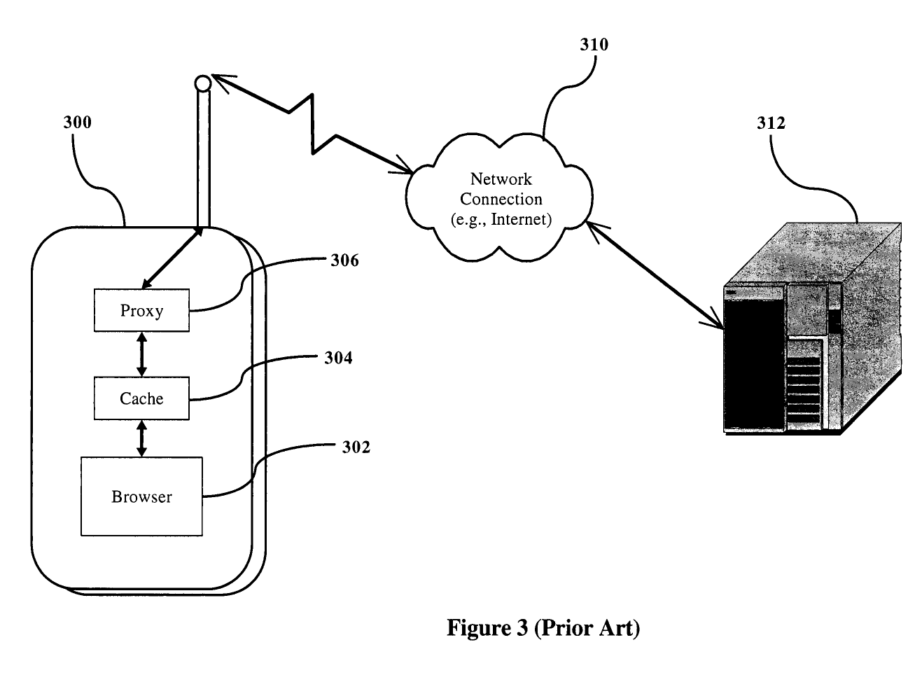

FIG. 3 illustrates a prior art mobile-to-enterprise system currently in use. A wireless device, e.g., PDA 300, includes a browser 302, a cache 304, and a proxy 306. The PDA 300 communicates with an enterprise server 312 via a wireless network connection 310, e.g., the Internet. Browser 302 functions to give a user the ability to view content such as, for example, a web page served by enterprise server 312. In a known manner, the user executes a command (e.g., tapping on an icon or manually inputting a URL) which sends a desired URL to the enterprise server via the network connection 310. The network server 312 serves the requested URL and its content back to the PDA 300 over the network connection 310. It is received and viewed on browser 302, and, assuming the PDA 300 is configured properly, the content is also stored in cache 304.

In most cases, the cache 304 and proxy 306 are only used when the PDA 300 is not in a connected state with server 312. For example, the user of the PDA 300 may be in a location where wireless communication is impossible, such as in the interior of a building that does not have access to wireless network connections, or a remote location that is not within the proximity of wireless transmission and receiving systems. Further, it is not financially efficient to be connected at all times; thus, wireless devices typically are operated in a disconnected state as much as possible. When in this disconnected state, if the user wishes to view previously viewed content, the user simply attempts to access the URL of the previously existing content, and cache 304 serves the stored information to the browser for viewing. As long as the desired content is not constantly changing, this system functions adequately. Further, as long as the content being requested by the user in this disconnected state has been previously accessed, it will be available for viewing in the cache. However, if the information being retrieved is time-sensitive (e.g., news content, stock quotes, etc.) or if an attempt is made to access a link from a previously accessed (cached) site where the link has never been accessed previously, the user will be unable to retrieve the most current content (or, in the example of the previously unvisited link, the user will not be able to retrieve content at all).

The proxy 306 comes into play when the user is attempting to send information to a particular URL on server 312. For example, if the user is accessing a URL from server 312 that contains forms that require inputting of information, when the user is not connected to the network, the forms can be retrieved from cache 304, filled out by the user, and when the user attempts to send them to server 312, they will instead be routed to proxy 306 where they will be saved until the next network connection is made. When the next network connection is made, the input by the user will be forwarded to the appropriate location on the server 312.

Since the user needs to direct the newly input data to the proxy instead of to the server 312, the URL that the user is attempting to contact on the server 312 must be rewritten to direct the browser to the proxy 306. This is accomplished by interposing the content delivered to the browser for the initial request of the page by the proxy, and parsing the data and rewriting URL references so that they refer back to the proxy instead of the initial intended target. However, this requires rewriting of the URL, as well as additional processing power, which is at a premium in many PDA devices.

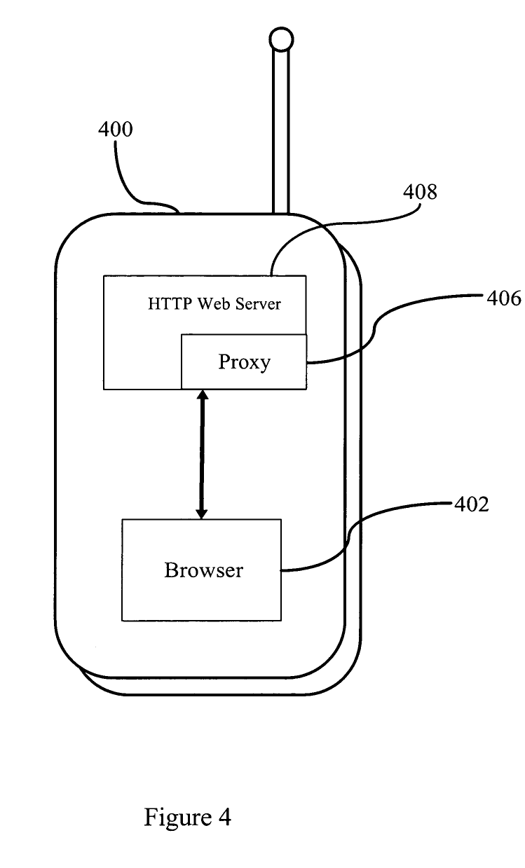

FIG. 4 illustrates an example of a PDA 400 configured in accordance with the present invention. The connection between the PDA and the enterprise server (e.g., enterprise server 312 of FIG. 3) is identical to that illustrated in FIG. 3 and thus only the PDA is illustrated in FIG. 4. As seen in FIG. 4, in accordance with the present invention, PDA 400 has a WOX 408 (a combined Web server and prOXy) residing on the PDA itself. The WOX 408 includes a proxy 406 and an HTTP web server 407 in communication with browser 402.

In accordance with the present invention, HTTP web server 407 is a mirror server that carries content identical to that found on the enterprise server 312. The mirror server can carry all of the content available in the enterprise server; however, from a practical standpoint, in order to best utilize limited resources of the hand-held device, the mirror server can be configured to contain only content defined for that particular device so that extraneous content that is unlikely to be accessed by a user of the device does not need to be stored thereon.

The WOX 408 operates both as an HTTP server and a proxy. Since WOX 408 is both an HTTP server and a proxy, it “morphs” itself between functions depending upon the connection status of the hand-held device. For example, when in a disconnected state, the WOX is configured, e.g., programmatically through an IF statement for checking the connection status, to operate like a local web server serving pages to the browser 402 of the hand-held device 400, as described above. However, when data is posted to the WOX 408 or HTTP server 407 using, for example, a form that is filled out by the user, the WOX 408 stores the data, since there is no connection available to transfer the data to the enterprise server. Later, when a connection to the enterprise server becomes available, the WOX acts as a proxy (via proxy 406) to proxy the data to the enterprise server. The WOX 408 also provides the functionality to create the local website mirror from the enterprise server, via known program instructions stored on WOX 408 that copy web files from the enterprise server to WOX 408.

By having a mirror server directly on the PDA 400, when a user attempts to communicate with a particular site in order to input data (e.g., the above-described form data) to the URL on the remote server 312, if disconnected from the network, the same URL that is used to contact the remote server 312 can be used to input the data to WOX 408. In other words, there is no need to rewrite the URL; instead, the identical URL is utilized. The input data is stored on WOX 408 when the hand-held device 400 is disconnected from the network. Upon reestablishing communication with the network, the WOX 408 proxies the stored data over the network to the remote server 312.

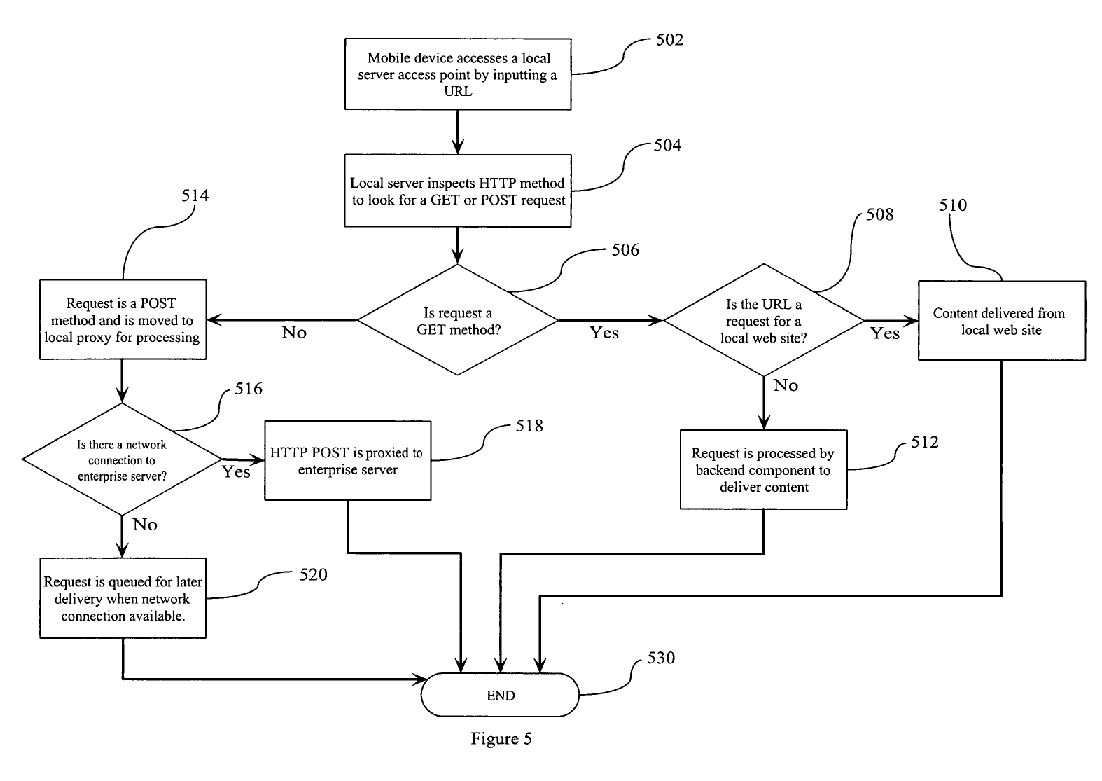

FIG. 5 is a flowchart illustrating an example of the processes performed by the present invention upon the input of a URL to a mobile device configured in accordance with the present invention. At step 502, the mobile device accesses the local server access point (WOX 408) by the inputting of a URL. At step 504, the WOX (via HTTP web server 407) inspects the HTTP data delivery method identified by the URL to determine if it is a GET or POST method.

If it is determined at step 504 that the URL is either a GET or POST request, then at step 506, a determination is made as to whether or not the request is a GET method. If the request is a GET method, the process proceeds to step 508 to determine if the URL that identifies the GET method is a request for a local website, i.e., one stored on HTTP web server 407. If the request is for a local website, the process proceeds to step 510, where the content is delivered from the HTTP web server 407 without accessing the network and/or the enterprise server. If, at step 508, it is determined that the URL is not a request for a local website, then the process proceeds to step 512, where the request is processed by a back-end component (e.g., a plug-in component such as a local DB2 database or Java application service) to deliver the content.

If at step 506, it is determined that the request is not a GET method, then the process is determined, by default, to be a POST method request, and at step 514, the POST method is moved to the local proxy 406 of WOX 408 for processing. At step 516, a determination is made as to whether or not there is a network connection to the enterprise server. If there is a network connection to the enterprise server, then the HTTP POST is proxied to the enterprise server and processed (the proxying also can perform authentication and security measures in connection with the WOX, for example, the WOX can use HTTPS when communicating with the enterprise server, thereby provising encrypted communication between the WOX and enterprise server). If, however, at step 516, it is determined that there is not a network connection to the enterprise server, then at step 520, the request is queued for later delivery to the enterprise server when the network connection becomes available. For example, the request can be stored in a local DB2 database or by storing it directly to storage media residing on the local device. The process ends at step 530.

Using the above-described invention, a mobile user has simplified access to web content, whether or not they are in a connected or disconnected state. Further, when the mobile user wishes to send information to the enterprise server, the information being posted is either delivered automatically when there is a connection to the network, or stored for later delivery upon the next connection to the network. Among the benefits the present invention provides is the ability to provide a secure transport mechanism for POST requests from any application through the proxy. For example, the POST request can use HTTP as the initial protocol to the local web server, but the proxy can use HTTPS to the enterprise server when delivering POSTs off of the device, thereby providing a secure mechanism. Alternatively, the WOX can store the credentials of the enterprise server (and vice versa) so that, in the event that a request is challenged, it can be verified.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage located on the hand-held device. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 4-5 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

1. In a device that is connectable to a server via a network, a method for providing local access to content stored on said server, comprising the steps of:
providing said device with a combination web server and proxy (WOX), said WOX mirroring said server;
whereby said WOX operates as a web server when processing an HTTP GET request and as a proxy when processing an HTTP POST request.

2. The method of claim 1, further comprising the steps of:
mirroring at least a subset of the content stored on said server on said WOX; and
delivering HTTP GET requests from said WOX when said device is disconnected from said network.

3. The method of claim 2, whereby a copy of all of said content stored on said server is mirrored on said WOX.

4. The method of claim 1, further comprising the steps of:
determining the connected/disconnected state of said device to said network;
wherein when said device is connected to said network, and an HTTP POST request is submitted to said WOX, said WOX delivers said HTTP POST request to said server; and
when said device is disconnected from said network, and an HTTP POST request is submitted to said WOX, said WOX stores the HTTP POST request for later delivery to said server.

5. The method of claim 4, whereby said stored HTTP POST requests are delivered to said server when said device next connects to the network.

6. The method of claim 4, whereby said HTTP POST requests and HTTP GET requests comprise requests in HTTPS format.

7. A system for interaction between devices and server resources via a network, said system comprising:
a device configured with a combination web server and proxy (WOX); and
a server connectable to said device;
whereby said WOX is configured to mirror said server, and operates as a web server when processing an HTTP GET request and as a proxy when processing an HTTP POST request.

8. The system of claim 7, wherein said WOX includes:
means for mirroring at least a subset of the content stored on said server; and
means for delivering HTTP GET requests from said WOX when said device is disconnected from said network.

9. The system of claim 8, wherein said WOX includes means for storing a copy of all of said content stored on said server.

10. The system of claim 7, further comprising:
means for determining the connected/disconnected state of said device to said network;
wherein when said device is connected to said network, and an HTTP POST request is submitted to said WOX, said WOX delivers said HTTP POST request to said server; and
when said device is disconnected from said network, and an HTTP POST request is submitted to said WOX, said WOX stores the HTTP POST request for later delivery to said server.

11. The system of claim 10, further comprising means for delivering said stored HTTP POST requests to said server when said device next connects to the network.

12. The system of 10, whereby said HTTP POST requests and HTTP GET requests comprise requests in HTTPS format.

13. A computer program product for interaction between devices and server resources via a network, said computer program product comprising a computer-readable storage medium having computer-readable program code embodied in the medium, the computer-readable program code comprising:
computer-readable program code that configures said devices as a combination web server and proxy (WOX); and
computer-readable program code that enables connectivity between said devices and a server;
whereby said WOX is configured to mirror said server, and operates as a web server when processing an HTTP GET request and as a proxy when processing an HTTP POST request.

14. The computer program product of claim 13, wherein said WOX includes:
computer-readable program code for mirroring at least a subset of the content stored on said server; and
computer-readable program code for delivering HTTP GET requests from said WOX when said device is disconnected from said network.

15. The computer program product of claim 14, wherein said WOX includes computer-readable program code for storing a copy of all of said content stored on said server.

16. The computer program product of claim 13, further comprising:
computer-readable program code for determining the connected/disconnected state of said device to said network;
wherein when said device is connected to said network, and an HTTP POST request is submitted to said WOX, said WOX delivers said HTTP POST request to said server; and
when said device is disconnected from said network, and an HTTP POST request is submitted to said WOX, said WOX stores the HTTP POST request for later delivery to said server.

17. The computer program product of claim 16, further comprising computer-readable program code for delivering said stored HTTP POST requests to said server when said device next connects to the network.

18. The computer program product of claim 16, whereby said HTTP POST requests and HTTP GET requests comprise requests in HTTPS format.
